(19) United States
(12) Patent Application Publication
(10) Pub. No.: US 2022/0404107 A1
(43) Pub. Date: Dec. 22, 2022

(54) HEAT EXCHANGER AND ADSORPTION MACHINE

(71) Applicant: FAHRENHEIT GMBH, Halle/Saale (DE)

(72) Inventors: Rainer Pischel, Halle (DE); Ralph Herrmann, Halle (DE); Walter Mittelbach, Freiburg (DE)

(21) Appl. No.: 17/770,729

(22) PCT Filed: Dec. 10, 2020
(86) PCT No.: PCT/EP2020/085594

§ 371 Date: Apr. 21, 2022

(30) Foreign Application Priority Data
Dec. 16, 2019 (DE) 102019134587.1

(51) Int. Cl. F28F 1/12; F25B 17/08; F28F 13/18

(52) U.S. Cl. CPC F28F 1/12; F25B 17/08; F28F 13/185

(57) ABSTRACT

The invention relates to a heat exchanger (10) of an adsorption machine, comprising—at least two heat transport pipes (15) and/or heat transport pipe sections, which are arranged at a distance (A) with respect to one another in such a way as to form at least one interspace, which is designed as a steam flow duct (18), —and pipe attachments (20) connected to the heat transport pipes (15) and/or heat transport pipe sections. According to the invention, the pipe attachments (20) are arranged in the interspace and designed as a substrate for a directly applied, binder-free active material coating (25), wherein the heat transfer grid (50) consisting of the coated pipe attachments (20) together with the heat transport pipes (15) and/or heat transport pipe sections has a steam-side outer surface of 500-3600 m²/m³.

The invention relates to a heat exchanger of an adsorption machine, comprising at least two heat transport pipes or heat transport pipe sections, which are arranged at a distance with respect to one another in such a way as to form at least one interspace, which is designed as a steam flow duct, and further pipe attachments connected to the heat transport pipes and/or heat transport pipe sections, according to the preamble of claim 1. The invention relates in addition to a heat exchanger of an adsorption machine, comprising at least one heat transport pipe and/or one heat transport pipe section, and pipe attachments connected to the heat transport pipe and/or the heat transport pipe section, wherein at least on one side of the heat transport pipe and/or the heat transport pipe section, a steam flow area is designed or designable, according to claim 14. Furthermore, the invention relates to an adsorption machine having a heat exchanger according to the invention.

It is known from the state of the art to design three-dimensional heat exchanger structures or heat exchangers with adsorbing active layers, e.g., zeolite layers. The masses of adsorbing active material are limited in adsorption heat pumps for reasons of material and heat transport in their production and in operation on their level above the nearest heat exchanger surface and thus in their mass per area. Due to that, hitherto known adsorption heat pumps do not achieve sufficient performance in case of compactness conditioned by application.

Hitherto known and available adsorber heat exchangers often have the disadvantage of only being inhomogeneously coated with so-called active materials.

It is furthermore known that the steam ducts formed within the adsorber heat exchanger are blocked by active material. This, in turn, leads to poor accessibility of the active material of the adsorber heat exchanger and moreover to insufficient calcination results.

Usual copper pipe heat exchangers provided with aluminum lamellae are likewise disadvantageous since only small volume-specific surfaces are possible and the thermal connection between the lamellae and the pipe is insufficient. Further known heat exchangers, which have fiber fills as pipe attachments, likewise must be designated as being disadvantageous, since there is insufficient contacting with the associated heat transport ducts due to the disordered fiber arrangement, which is for the most part situated transversely to the heat conduction direction.

Starting from the current state of the art, the task of the present invention is to further develop a heat exchanger of an adsorption machine such that the performance of an associated adsorption machine is increased in case of compactness conditioned by application. Furthermore, the heat exchanger according to the invention should be configured such that an active material can be applied onto areas of the heat exchanger within a crystallization process. This should be performed such that no steam ducts are blocked.

Furthermore, it is the task of the invention to propose a further developed adsorption machine, which is in particular further developed with respect to the heat exchanger.

This task is solved with respect to the heat exchanger by the subject matter of claim 1 as well as the subject matter of claim 14, and with respect to the adsorption machine by the subject matter of claim 15. The subclaims comprise at least appropriate configurations and further developments.

First, a heat exchanger of an adsorption machine is taken as a basis, wherein the heat exchanger comprises:
at least two heat transport pipes and/or heat transport pipe sections, which are arranged at a distance with respect to one another in such a way as to form at least one interspace, which is designed as a steam flow duct,
and pipe attachments connected to the heat transport pipes and/or heat transport pipe sections.

According to the invention, the pipe attachments are arranged in the interspace and designed as a substrate for a directly applied, in particular grown up, binder-free active material coating, wherein the heat transfer grid consisting of the coated pipe attachments together with the heat transport pipes and/or heat transport pipe sections has a steam-side outer surface of 500-3,600 m²/m³, in particular of 800-3,200 m²/m³.

The collectors or collector pipes substantially designed on the front sides of the heat exchanger do not need to be included in the resulting heat transfer grid. Preferably, such collectors are designed to be substantially perpendicular to the heat transport pipes and/or heat transport pipe sections and serve for the inflow and outflow of heat transport medium flowing through the heat transport pipes and/or heat transport pipe sections.

In other words, the heat exchanger comprises at least two heat transport pipes and/or heat transport pipe sections, wherein pipe attachments are designed between these heat transport pipes and/or heat transport pipe sections. These pipe attachments are in particular connected to the heat transport pipes and/or heat transport pipe sections.

An active material coating may in turn be applied onto these pipe attachments. By the surface of the coated heat transport pipes and/or heat transport pipe sections resulting therefrom, which can be contacted by a steam flowing through the steam flow duct, a steam-side outer surface of the heat exchanger is formed. The application of an active material coating relates in particular to growing up an active material coating.

It is also possible for the heat transport pipes and/or heat transport pipe sections to be coated with the binder-free active material. In other words, a binder-free active material coating may be situated on the heat transport pipes and/or heat transport pipe sections. This relates in particular to the portions of the heat transport pipes and/or heat transport pipe sections, which are designed as a part of a steam flow duct.

As a heat transport pipe, such a pipe is to be understood, which is arranged separated form a further pipe. As the heat transport pipe section, a section of the heat transport pipe is to be understood, which is designed to be spaced from a further heat transport pipe section by the configuration of bends. It is in particular possible for two heat transport pipe sections to run substantially in parallel to one another, wherein the heat transport pipe sections fluidically constitute a common heat transport pipe or are part of a heat transport pipe.

In a possible embodiment of the invention, the mentioned heat transfer grid consists only of an outer surface formed by the active material coating. This active material coating is in this case formed both on the pipe attachments and at least in sections on portions of the heat transport pipes and/or heat transport pipe sections facing towards the steam flow duct.

Preferably, these heat transport pipes and/or heat transport pipe sections are designed as flat ducts and/or ducts having a rectangular cross-section. It is therefore preferably deviated from the round pipes known as a standard, and a flat duct and/or a duct having a rectangular cross-section is formed. Such a duct is to be understood as a flat duct, which constitutes a compressed pipe, for example. The flat ducts may also be divided into several single ducts by inner webs. By means of such flat ducts or ducts having a rectangular cross-section, it is possible to provide a heat exchanger, which is further developed in a preferred form with respect to the interspace and the pipe attachments contained therein. Due to such flat ducts and/or ducts having a rectangular cross-section, the pipe attachments may be more stably mounted and fixed between the heat transport pipes and/or heat transport pipe sections.

According to the invention, the sorption-side heat exchanger surface is increased despite of limited outer dimensions for achieving preferred active material masses and thus for improving the performance of the heat exchangers in an adsorption machine.

The area per volume of the heat exchanger accessible for the coating, i.e., the volume area is maximized to be as great as possible, wherein a coating with active material, in particular a crystallization, is possible at the same time without blocking the formed steam ducts.

The heat transport pipes and/or heat transport pipe sections may be formed from extruded or soldered flat pipes. It is furthermore possible for the heat transport pipes and/or heat transport pipe sections to be formed from plates arranged to one another.

The pipe attachments may be designed, for example, as fins and/or lamellae and/or woven layers and/or knitted layers and/or fiber layers and/or chip layers. The term “fin” is to be understood as the German translation of the technical terminology “fin” known from English.

The pipe attachments may also be designated as surface-enlarging elements or surface-enlarging attachments.

In forming fins and/or lamellae it is also possible to form them from a metal film. If the pipe attachments are designed as lamellae, several stripes of a metal film are arranged spaced from one another. If the pipe attachments are designed as fins, a metal film is folded and/or buckled and/or bent repeatedly so that, for example, a zigzag structure or a wave structure or a meander structure or a serpentine structure is formed.

In particular such pipe attachments are to be understood as lamellae, which are formed from single, strip-like elements, wherein these strip-like elements are arranged within the interspace to be spaced from one another.

Preferably, such pipe attachments are to be understood preferably as fins, which consist of a continuous element, which has been repeatedly folded and/or bent and is formed within the interspace between two heat transport pipes and/or heat transport pipe sections. The element bent and/or folded into fins, may have a zigzag-like course, for example. It is further possible for the element to be bent serpentine-like, so that a plurality of bending portions is formed, which, in turn, constitute the fins.

The woven layers may be such layers, which relate to a fabric formed from metal fibers. Also, the knitted layers are such layers that are produced from metallic continuous filaments. In other words, such woven and/or knitted layers will not form an arrangement of short fibers. Such fibers are to be understood as short fibers, which have a length of 1 cm, for example.

It is possible for several woven layers and or knitted layers to be arranged next to one another within the interspace, so that, in turn, intervals can be built between the woven and/or knitted layers. In a further embodiment of the invention, it is possible for the interspace to be completely filled by a woven layer and/or a knitted layer, wherein the woven layers and/or the knitted layers are formed in such a porous way that a steam duct will not be blocked. Such a woven and/or knitted layer is in particular to be formed in such a porous way that even after the application of an active material, no steam ducts will be blocked.

It is furthermore possible for the pipe attachments to be formed as fiber layers and/or chip layers. Such fiber layers and/or chip layers are formed such that these do not relate to loose fills of fibers or chips. Rather, these fiber layers and/or chip layers are to be understood as a kind of felt layers, which are formed from metal fibers or metal chips that have been pressed and/or sintered together.

In a possible embodiment of the invention, the metal chips forming the chip layers may be helical chips. These fibers and/or chips are pressed and/or sintered and/or glued together in such a manner that a fiber layer and/or a chip layer are/is formed.

It is possible for the interspace to be in each case completely filled by a single fiber layer and/or chip layer. Also, the configuration of several fiber layers and/or chip layers, which are formed spaced from one another, is possible. In case of such an embodiment of the invention, however, attention must be paid that the fiber layer and/or the chip layer are/is formed in such a porous way that even after the application of an active material, no steam ducts are blocked.

Preferably, the pipe attachments are formed from aluminum. Also, the heat transport pipes and/or heat transport pipe section may be produced from aluminum. Preferably, the pipe attachments are soldered and/or sintered and/or glued together with the heat transport pipes and/or heat transport pipe sections. As far as the heat transport pipes and/or heat transport pipe sections are formed from the same materials as the pipe attachments, for example, aluminum, a simple fixing of the pipe attachments to the heat transport pipes and/or heat transport pipe sections can be enabled.

A consistent material selection moreover simplifies the process of applying the active material layer and forming the active material layer, since no different reactions will occur during the application of the active material.

The pipe attachments may be designed as metal stripes. It is possible for such stripes to have an incised structure.

The pipe attachments are arranged such as to be open for liquids and/or gases and/or steams, starting from a steam flow opening across the entire depth of the heat exchanger.

The active material coating may have a mean layer thickness of 20 μm to 500 μm, in particular of 30 μm to 300 μm.

An active material mass of 30 to 500 g/m², in particular of 50 to 250 g/m², proves to be particularly advantageous. An active material coating having the indicated layer thickness and/or active material mass proves to be especially advantageous in being applied in adsorption heat pumps.

The thickness of the pipe attachments, in particular of the fins and/or lamellae, preferably is more than 50 μm, in particular more than 100 μm. Furthermore, this thickness of the pipe attachments, in particular of the fins and/or lamellae, is less than 500 μm. in particular less than 250 μm. In other words, the thickness of the pipe attachments, in particular of the fins and/or lamellae, preferably is 50 μm to 500 μm, in particular 100 μm to 250 μm.

Preferably, the pipe attachments within the steam flow channel have a mean distance of 0.2 mm to 3.0 mm from one another. In other words, the fins and/or lamellae having a mean distance of 0.2 to 3.0 mm are spaced from one another. In particular when fins are formed, the mean distance is to be understood as the distance, when the fin extends vertically to the two heat transport pipes and/or heat transport pipe sections is related to the average mean distance. This distance is formed approximately centrically between the two heat transport pipes and/or heat transport pipe sections. In other words, the mean distance is formed to be approximately half of the distance between the two heat transport pipes and/or heat transport pipe sections.

The pipe attachments within the steam flow duct preferably have an area of 800 to 4.000 m²/m³, in particular of 1.100 to 3.200 m²/m³.

The distance between the heat transport pipes and/or heat transport pipe sections preferably is 4.0 to 30.0 mm, in particular 8.0 to 15.0 mm. This enables a compact design of the heat exchanger, on the one hand, and a sufficient interspace for forming pipe attachments, on the other hand.

A particularly effective shape of the heat exchanger can be formed if a pitch number of pipe attachments arranged within the interspace, in particular of fins arranged next to one another, is between 0.7 and 2.5. The pitch number relates to the configuration of fin curves per millimeter. A pitch number of such a configuration enables sufficient distance between the fins and a corresponding layer thickness of an active material coating.

In a further embodiment of the invention, it is possible that on the level of the mean distance of the pipe attachment, in particular of fins arranged next to one another, the mean distance between opposite active material surfaces is at least 1.5 times larger than the mean layer thickness of the active material coating. When such a relationship between the mean distance of the opposite active material surfaces and the mean layer thickness is formed, a sufficiently great steam duct is left open.

It is to be pointed out that the level of the mean distance of the pipe attachments, in particular of the fins arranged next to one another, may have a different position depending on the pattern of the pipe attachments, in particular of the pattern of the arranged fins.

The active material, for example, may be zeolite and/or a porous aluminum phosphate and/or a metal organic framework (MOF). Active materials that have high adsorption capacities and enable rapid adsorption and desorption processes are particularly suitable.

Apart from the selection of a suitable absorbing active material, unimpeded access of the gaseous adsorbent to the outer surface of the active material, very good accessibility of the pore system, and the renunciation of binder material by directly contacting the active material with the pipe attachments are a prerequisite. Very good accessibility of the pore system is to be understood in the sense of a material transport. Directly contacting the pipe attachment with the active material improves the heat transport.

Preferably, the active materials are applied onto the pipe attachments by a direct coating process, in particular by a crystallization process, and thus an active material coating is produced. This represents an essential advantage as compared to known adsorbent fills or binder coatings. With such adsorbent fills or binder coatings, it is not possible to achieve such good sorption performances as are possible with the heat exchanger according to the invention.

In an especially preferred embodiment of the invention, the active material is applied by means of crystallization as an in-situ process. In EP 1 761 657 131, such zeolite growth is described. Reference is herewith made completely to the content of disclosure of this document.

Preferably, the length of the maximum heat transport path from a surface of the active material coating up to the inner side of the nearest heat transport pipe and/or heat transport pipe section is 2.5-8.0 mm, in particular 3.0-5.0 mm. This value with respect to the maximum heat transport path is an important parameter with respect to the performance optimization of a heat exchange of an adsorber or an adsorption machine.

The heat transport path is the path from the entry of the adsorbate at a simultaneous release of the adsorption enthalpy up to the transmission of the generated heat into the temperature-controlling fluid, thus the path from the adsorbent up to the temperature-controlling fluid.

Since the structure of the heat exchange is based on the fact that the pipe attachments are formed between at least two heat transport pipes and/or heat transport pipe sections and the active material coating is formed on the pipe attachments, the most maximum heat transport path preferably is given in conjunction with the surface or the surface portion of the active material coating, which is formed centrically between the at least two heat transport pipes and/or heat transport pipe sections.

The heat transport path thus begins at maximum on the level of half of the distance between the heat transport pipes and/or heat transport pipe sections, and ends on the inner side of the nearest heat transport pipe and/or heat transport pipe section. The nearest heat transport pipe and/or heat transport pipe section is the heat transport pipe and/or heat transport pipe section having the smallest distance from the corresponding surface or the corresponding surface portion of the active material coating.

The described lengths of the maximum heat transport path of 2.5-8.0 mm, in particular 3.0-5.5 mm, are a relevant value with respect to high efficiency and great performance of the heat exchanger according to the invention. A great performance of the heat exchange reflects a short cycle time.

A further subordinate aspect of the invention relates to a heat exchanger of an adsorption machine, comprising:
at least one heat transport pipe and/or at least one heat transport pipe section,
and pipe attachments connected to the heat transport pipe and/or the heat transport pipe section,
wherein at least on one side of the heat transport pipe and/or the heat transport pipe section, a steam flow area is designed or designable,
wherein the pipe attachments are arranged at least on this side of the heat transport pipe and/or heat transport pipe section and are designed as a substrate of a directly applied, binder-free active material coating, wherein the heat transfer grid resulting from the coated pipe attachment together with the heat transport pipe and/or heat transport pipe section has a steam-side outer surface of 500-3,600 m²/m³, in particular of 800-3,200 m²/m³.

As compared to the preceding explanations in conjunction with the heat exchanger, the heat exchanger according to the further subordinate aspect of the invention has only at least one heat transport pipe and/or only at least one heat transport pipe section.

In this aspect of the invention, for example, an open heat exchanger may be designed, and consequently the pipe attachments are only formed on one heat transport pipe and/or heat transport pipe section, wherein the pipe attachments are not situated in a closed housing.

It is furthermore possible for the pipe attachments to be formed between a heat transport pipe and/or a heat transport pipe section and, for example, a housing portion. Instead of the housing portion, a sheet metal-like element may also be formed.

In conjunction with the heat exchanger according to the subordinate aspect of claim 14 it is possible for at least one of the features of subclaims 2 to 14 to be formed in addition.

The heat exchanger according to claim 14, may have, for example
an already described form of the heat transport pipe and/or of the heat transport pipe section,
   and/or
an already described embodiment of the pipe attachments,
   and/or
an already described embodiment of the active material coating,
   and/or
an already described embodiment of the thickness of the pipe attachments,
   and/or
an already described embodiment of the arrangement of the pipe attachments with respect to one another,
   and/or
an already described embodiment of the active material,
   and/or
an already described embodiment of the length of the maximum heat transport path.

The heat exchanger according to claim 14 may explicitly be combined with at least one of the claims 2 to 13.

A further subordinate aspect of the invention relates to an adsorption machine having a heat exchanger according to the invention.

In conjunction with the adsorption machine according to the invention, similar advantages as already indicated in conjunction with the heat exchanger according to the invention are the result.

Exemplary embodiments of the inventive solution will be explained below in more detail on the basis of attached schematical drawings.

Shown are in:

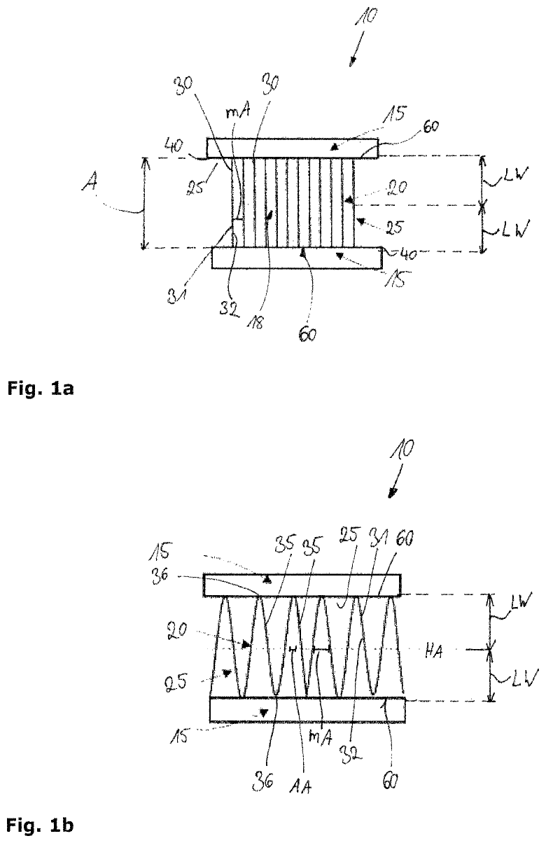

FIGS. 1a and 1b various embodiments of a heat exchanger according to the invention in a side view;

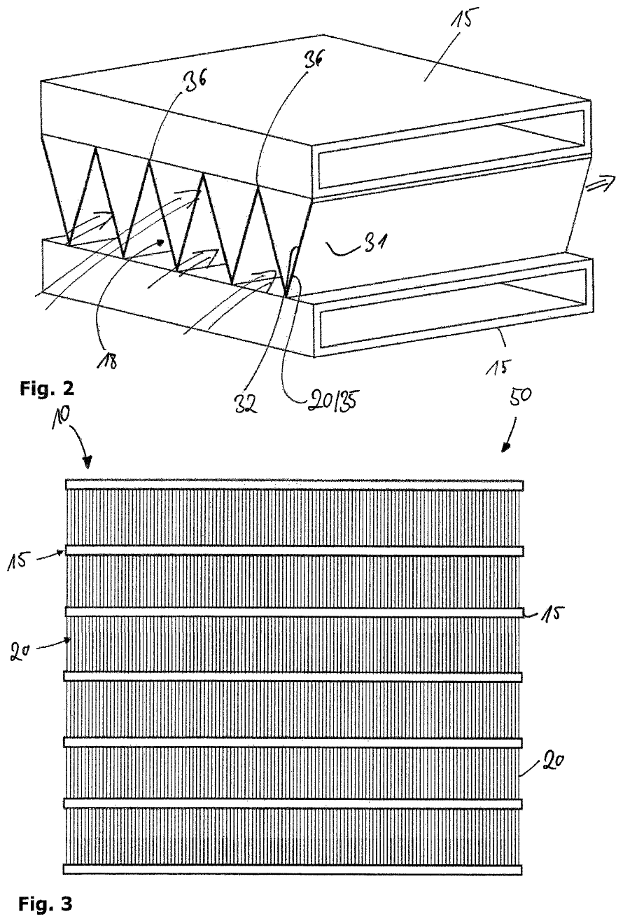

FIG. 2 an embodiment of the heat exchanger according to the invention in a perspective view; and

FIG. 3 the illustration of a heat transfer grid.

In the following, the same reference numerals will be used for identical parts or parts of identical action.

In FIGS. 1a and 1b, heat exchangers 10 according to the invention or at least a section of a heat exchanger 10 according to the invention are illustrated.

A heat exchanger 10 or a partial segment of a heat exchanger 10 substantially comprises two heat transport pipes 15, which are arranged at a distance A from one another. The distance between the heat transport pipes 15 preferably is 4.0 mm to 30.0 mm, in particular 8.0 mm to 15.0 mm.

Due to this distance A, an interspace is built between the two heat transport pipes 15. This interspace is formed as a steam flow duct 18. In the direction of vision onto the heat exchanger 10 according to FIG. 1a, steam may thus flow into the steam flow duct 18.

Furthermore, it can be recognized that pipe attachments 20 are formed between the heat transport pipes 15. The pipe attachments 20 are arranged within the interspace and thus within the steam flow duct 18, and serve as a substrate of a directly applied, binder-free active material coating 25.

According to the embodiment in FIG. 1a, the pipe attachments 20 are formed from lamellae 30. The lamellae 30 are substantially formed from metal stripes arranged between the two heat transport pipes 15. Preferably, the lamellae 30 are made of an aluminum material. The heat transport pipes 15 as well are preferably formed from aluminum. In the present exemplary embodiment, the lamellae 30 are arranged to be uniformly spaced from one another. The lamellae 30 are soldered together with the heat transport pipes 15, for example.

The lamellae 30 substantially have two large side faces 31 and 31. Both sides 31 and 32 are provided with the active material coating 25. Furthermore, surface portions 40 of the heat transport pipes 15 as well are coated with active material and thus have an active material coating 25.

The coated lamellae 30 together with the heat transport pipes 15 build a heat transfer grid having a steam-side outer surface of 500-3,600 m²/m³.

The active material coating 25 preferably has a layer thickness of 30 to 300 μm. Furthermore, the active material mass preferably is 30-500 g/m².

The thickness of the pipe attachments 20, in this case of the lamellae 30, preferably is between 50 μm and 500 μm, in particular 100 μm-250 μm. The thickness of the pipe attachments, in particular of the lamellae 30, is formed in FIG. 1a between the side faces 31 and 32. Between each of two lamellae 30, a mean distance mA of 0.2-3.0 mm is in particular formed.

All of the pipe attachments 20, i.e., in the present case all of the lamellae 30 form an area of 800-4.000 m²/m³ within the steam flow duct 18.

FIG. 1a furthermore shows the length of the maximum heat transport path LW. This maximum heat transport path LW extends from a surface of the active material coating 25 up to the inner side 60 of the respectively nearest heat transport pipe 15. The length is 2.5-8.0 mm, in particular 3.0-5.0 mm.

Since the structure of the heat exchanger 10 is based on the fact that the pipe attachments 20 are formed between at least two heat transport pipes 15, and the active material coating 25 is formed on the pipe attachments 20, the most maximum heat transport path LW is given in conjunction with the surface portion of the active material coating 25, which is formed centrically between the at least two heat transport pipes 15 or on the level of half the distance A between the heat transport pipes 15. The further surface portions each are arranged at a shorter distance from the heat transport pipes 15 and thus to the inner sides 60, so that the respective heat transport path is shorter than the plotted maximum heat transport path.

In FIG. 1b, an alternative embodiment with respect to the pipe attachments 20 is illustrated.

These pipe attachments are formed by fins 35. The fins 35 are in particular formed by bending a sheet metal or a metal layer. These fins 35 have two side faces 31, 32, which, in turn, are provided with an active material coating 25.

The fins 35 are in particular soldered together with the heat transport pipes 15. For this purpose, the fins 35 are connected to the heat transport pipes 15, for example, at the tops 36. These tops 36 may also be designated as peaks. The actual configuration does not need to be pointed. In fact, these areas 36 may be formed to be flatly rounded so that a connection to the heat transport pipes 15 is easily possible.

In the area of level HA, the mean fin distances mA are formed. The mean distance mA of the fins 35 from one another preferably is between 0.2 and 3.0 mm. The level HA relates in this case approximately to the mean distance of the two heat transport pipes 15 from one another.

The fins 35 are formed having such a distance mA from one another that a pitch number of less than 2 is formed. The pitch number describes in this case the number of fin curves, i.e., of two single fins per mm. The pitch number is in particular between 0.7 and 2.5.

On the level HA of the mean fin distance, the distance between the opposite active material surfaces AA is at least 1.5 times larger than the mean layer thickness of the active material coating. The distance between the opposite active material surfaces AA is, as it is illustrated in FIG. 1b, smaller than the mean distance mA. This distance AA is 1.5 times larger than the mean layer thickness of the active material coating 25.

In FIG. 1b, the length of the maximum heat transport path LW is moreover plotted. This maximum heat transport path LW extends from a surface of the active material coating 25 up to the inner side 60 of the respectively nearest heat transport pipe 15. The length is 2.5 to 8.0 mm; in particular 3.0 to 5.0 mm.

The most maximum heat transport path LW is given in conjunction with the surface portion of the active material coating 25, which is formed centrically between the at least two heat transport pipes 15. In the illustrated configuration of the pipe attachments 20 as fins 35, these are the surface portions that are formed on the level HA of the mean fin distances.

In FIG. 2, a part of the heat exchanger 10 is illustrated in a perspective view. It can be recognized in this view that the heat transport pipes 15 are formed as flat ducts or as ducts having a rectangular cross-section. A steam flow duct 18 is likewise illustrated. The steam can flow in between the ducts formed by the fins 35, and flows along the illustrated depth within the steam flow duct 18.

Furthermore, the steam flow outlet is also indicated. Due to the configuration of the heat transport pipes 15 as flat ducts, the pipe attachments 20 or the fins 35 in the illustrated example, can be mounted easily on the heat transport pipes 15. For this purpose, a connection is made in the area of the tops 36.

It is schematically illustrated in FIG. 3, which components of a heat exchanger 10 count among a heat transfer grid 50. In this case, all of the heat transport pipes 15 as well as the pipe attachments 20 arranged between the heat transport pipes 15 are concerned.

Not illustrated and also not belonging to the heat transfer grid 50, are the so-called collectors, which would be arranged according to the illustration of FIG. 3 left and right in a vertical extension. The heat transfer grid 50 extends over the entire depth (as illustrated in FIG. 2) of the heat exchanger 10.

### LIST OF REFERENCE NUMERALS

10 heat exchanger
15 heat transport pipe
18 steam flow duct
20 pipe attachment
25 active material coating
30 lamella
31, 32 side face
35 fin
36 top, peak
40 surface portion
50 heat transfer grid
60 inner side
A distance of heat transport pipe
AA distance of active material surfaces
HA level of mean fin distance
LW length of maximum heat transport path
mA mean distance

1. A heat exchanger (10) of an adsorption machine, comprising:
at least two heat transport pipes (15) and/or heat transport pipe sections, which are arranged at a distance (A) with respect to one another in such a way as to form at least one interspace, which is designed as a steam flow duct (18),
and pipe attachments (20) connected to the heat transport pipes (15) and/or heat transport pipe sections,
characterized in that
the pipe attachments (20) are arranged in the interspace and designed as a substrate for a directly applied, binder-free active material coating (25), wherein the heat transfer grid (50) consisting of the coated pipe attachments (20) together with the heat transport pipes (15) and/or heat transport pipe sections has a steam-side outer surface of 500-3,600 m²/m³, in particular of 800-3,200 m²/m³.

2. The heat exchanger (10) according to claim 1,
characterized in that
the heat transport pipes (15) and/or heat transport pipe sections are designed as flat ducts and/or ducts having a rectangular cross-section.

3. The heat exchanger (10) according to claim 1,
characterized in that
the pipe attachments are designed as fins (35) and/or lamellae (30) and/or woven layers and/or knitted layers and/or fiber layers and/or chip layers.

4. The heat exchanger (10) according to claim 1,
characterized in that
the active material coating (15) has a mean layer thickness of 20-500 μm, in particular of 30-300 μm and an active material mass of 30-500 g/m², in particular of 50-250 g/m².

5. The heat exchanger (10) according to claim 1,
characterized in that
the pipe attachments (20) are formed from aluminum and are soldered and/or sintered and/or glued together with the heat transport pipes (15) and/or heat transport pipe sections.

6. The heat exchanger (10) according to claim 1,
characterized in that
the thickness of the pipe attachments (20) is >50 μm, in particular >100 μm, and <500 μm, in particular <250 μm.

7. The heat exchanger (10) according to claim 1,
characterized in that
the pipe attachments (20) within the steal flow duct (18) have a mean distance (mA) of 0.2-3.0 mm from one another.

8. The heat exchanger (10) according to claim 1,
characterized in that
the pipe attachments (40) within the steam flow duct (18) have an area of 800-4.000 m²/m³, in particular of 1.100-3.200 m²/m³.

9. The heat exchanger (10) according to claim 1,
characterized in that
the distance (A) between the heat transport pipes (15) and/or heat transport pipe sections is 4.0-30.0 mm, in particular 8.0-15.0 mm.

10. The heat exchanger (10) according to claim 3,
characterized in that
the pitch number of pipe attachments arranged within the interspace, in particular of fins (35) arranged next to one another, is between 0.7 and 2.5.

11. The heat exchanger (10) according to claim 3,
characterized in that
on the level (HA) of the mean distance of the pipe attachments (20), in particular of fins (35) arranged next to one another, the mean distance (AA) between opposite active material surfaces is at least 1.5 times larger than the mean layer thickness of the active material coating (25).

12. The heat exchanger (10) according to claim 1,
characterized in that
the active material is zeolite and/or a porous aluminum phosphate and/or a metal organic framework.

13. The heat exchanger (10) according to claim 1,
characterized in that
the length of the maximum heat transport path (LW) from a surface of the active material coating (25) up to the inner side (60) of a nearest heat transport pipe (15) and/or heat transport pipe section is 2.5 to 8.0 mm, in particular 3.0 to 5.0 mm.

14. A heat exchanger (10) of an adsorption machine, comprising:
at least one heat transport pipe (15) and/or at least one heat transport pipe section,
and pipe attachments (20) connected to the heat transport pipe (15) and/or heat transport pipe section,
wherein at least on one side of the heat transport pipe (15) and/or the heat transport pipe section, a steam flow area is designed or designable,
wherein the pipe attachments (20) are arranged at least on this side of the heat transport pipe (15) and/or heat transport pipe section and are designed as a substrate of a directly applied, binder-free active material coating (25), wherein the heat transfer grid (50) resulting from the coated pipe attachment together with the heat transport pipe (15) and/or heat transport pipe section has a steam-side outer surface of 500-3,600 m²/m³, in particular of 800-3,200 m²/m³.

15. An adsorption machine having a heat exchanger (10) according to claim 1.
